(19) United States
(12) Patent Application Publication
(10) Pub. No.: US 2009/0307085 A1
(43) Pub. Date: Dec. 10, 2009

(54) SYSTEM FOR DISPLAYING INVENTORY SEARCH PARAMETERS FOR AN ADVERTISER

(75) Inventors: Lisandro Miguel Lejano, Foster City, CA (US); Erik Ruben Racho, Arcadia, CA (US); Claude Jones, San Marcos, CA (US)

Correspondence Address: BRINKS HOFER GILSON & LIONE / YAHOO! OVERTURE, P.O. BOX 10395, CHICAGO, IL, 60610, US

(73) Assignee: YAHOO! INC., Sunnyvale, CA (US)

(21) Appl. No.: 12/130,667

(22) Filed: May 30, 2008

(51) Int. Cl. G06Q 10/00; G06Q 30/00

(52) U.S. Cl. 705/14.49; 705/14.73

(57) ABSTRACT

A system and method are disclosed with a search summary pane that automatically displays features that are selected for matching advertisements with available ad space. An ad broker interface may be provided for identifying advertisements and identifying available ad space by selecting common features for the matching of advertisements with the available ad space. As the user selects features on the interface, the selected features are automatically displayed in a search summary pane that lists each previously selected feature.

### RELATED APPLICATIONS

The present application relates to applications entitled “SUPPLY CURVE PRICING IN A NETWORKED ADVERTISING ENVIRONMENT,” (Atty. Dkt. 12729/442) filed on May 30, 2008, U.S. Ser. No. ______, now U.S. Pat. No. ______; “PLACEMENT PRICING IN A NETWORKED ADVERTISING ENVIRONMENT,” (Atty. Dkt. 12729/443) filed on May 30, 2008, U.S. Ser. No. ______, now U.S. Pat. No. ______; “AUTOMATIC AD GROUP CREATION IN A NETWORKED ADVERTISING ENVIRONMENT,” (Atty. Dkt. 12729/444) filed on May 30, 2008, U.S. Ser. No. ______, now U.S. Pat. No. ______; and “SYSTEM FOR DISPLAYING A POSITION VIEWER FOR PREVIEWING THE DISPLAY OF AN ADVERTISEMENT,” (Atty. Dkt. 12729/446) filed on May 30, 2008, U.S. Ser. No. ______, now U.S. Pat. No. ______; each of which is incorporated by reference.

### BACKGROUND

Online advertising may be an important source of revenue for enterprises engaged in electronic commerce. Processes associated with technologies such as Hypertext Markup Language (HTML) and Hypertext Transfer Protocol (HTTP) enable a web page to be configured to display advertisements. Advertisements may commonly be found on many web sites. For example, advertisements may be displayed on search web sites and may be targeted to individuals based upon search terms provided by the individuals. Other web site publishers, such as news and sports web sites, may provide space for advertisements. The publishers of these web sites may sell advertising space to advertisers to supplement the costs associated with operating the web sites as well as to turn a profit.

As the Internet has grown, the number of web sites available for hosting advertisements has increased, as well as the diversity between web sites. In other words, the number of web sites focusing on selective groups of individuals has increased. As a result of this increase, it has become increasingly difficult for advertisers to optimize the targeting of their advertisements. Advertisers may be unfamiliar with the vast number of web sites available for hosting advertisements and may choose to host their respective advertisements on a less than optimal host web site. This may result in a lower rate of return for the advertiser. That advertiser may have received a greater rate of return had the advertiser chosen a more suitable web site on which to display their advertisements.

### BRIEF DESCRIPTION OF THE DRAWINGS

The system and method may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 is a diagram of an exemplary network system;

FIG. 2 is a diagram of another exemplary network system;

FIG. 3 is a diagram of an exemplary advertising interaction;

FIG. 4 is an exemplary user interface;

FIG. 5 is an exemplary position viewer;

FIG. 6 is another exemplary position viewer with an above the fold position;

FIG. 7 is another exemplary position viewer with a spans the fold position;

FIG. 8 is another exemplary position viewer with a below the fold position;

FIG. 9 is another exemplary position viewer with a pop-up position;

FIG. 10 is another exemplary position viewer with a pop-under position;

FIG. 11 is another exemplary position viewer with an interstitial position;

FIG. 12 is another exemplary user interface with format selections;

FIG. 13 is another exemplary user interface with dimension selections;

FIG. 14 is another exemplary user interface with demographic targeting;

FIG. 15 is another exemplary user interface with an updated search summary pane;

FIG. 16 is another exemplary user interface with audience targeting;

FIG. 17 is another exemplary user interface with behavioral targeting;

FIG. 18 is another exemplary user interface with geographical targeting;

FIG. 19 is another exemplary user interface with content targeting;

FIG. 20 is a diagram using a search summary pane; and

FIG. 21 is a diagram using a position viewer.

### DETAILED DESCRIPTION

By way of introduction, a search summary pane is disclosed that automatically displays features that are selected for matching advertisements with available ad space. An ad broker interface may be provided for identifying advertisements and identifying available ad space by selecting common features for the matching of advertisements with the available ad space. As the user selects features on the interface, the selected features are automatically displayed in a search summary pane that lists each previously selected feature. In addition, a preview of the positioning of an advertisement within a page may be generated. An advertiser may identify a position for displaying its advertisements and a position viewer provides a preview display of the appearance of the advertisement at that position within a page. The position viewer may be a part of an interface for matching advertisements with available ad space. The automatic previewing of an advertisement in a selected position may assist an advertiser in identifying the optimal advertisement space for the advertisement.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims. Nothing in this section should be taken as a limitation on those claims. Further aspects and advantages are discussed below.

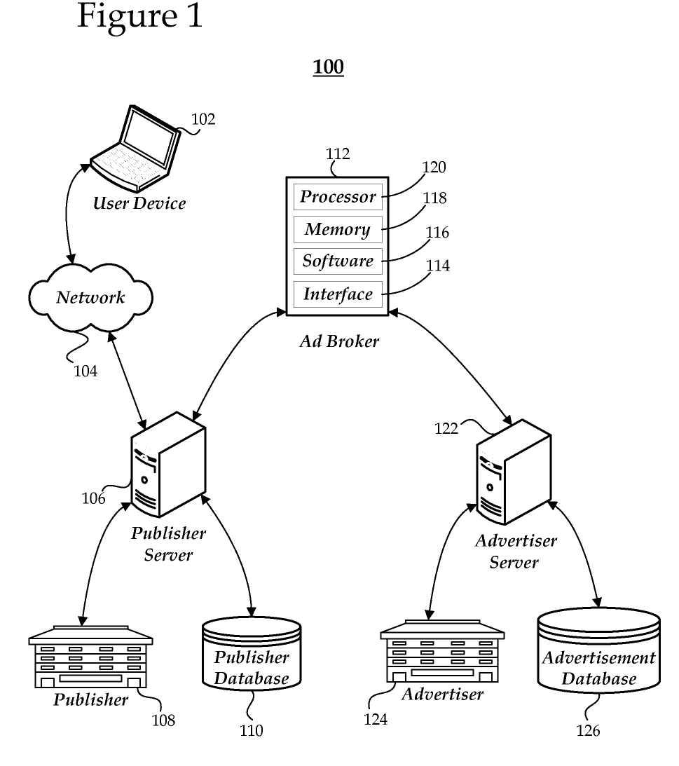

FIG. 1 depicts a block diagram illustrating one embodiment of an exemplary advertising system 100. The advertising system 100 may provide a platform for the identification, selection and display of advertisements included in pages, such as web pages. In the advertising system 100, a user device 102 is coupled with a publisher server 106 through a network 104. The publisher server 106 may be operated by and/or coupled with a publisher 108, as well as being coupled with a publisher database 110. An advertiser server 122 coupled with an advertiser 124 may also be coupled with an advertisement database 126. An ad broker 112 may be coupled with the publisher server 106 and the advertiser server 122. Herein, the phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

The user device 102 may be a computing device which allows a user to connect to a network 104, such as the Internet. Examples of a user device include, but are not limited to, a personal computer, personal digital assistant (“PDA”), cellular phone, or other electronic device. The user device 102 may be configured to allow a user to interact with the publisher server 106 or other components of the advertising system 100. The user device 102 may include a keyboard, keypad or a cursor control device, such as a mouse, or a joystick, touch screen display, remote control or any other device operative to allow a user to interact with the publisher server 106 via the user device 102. In one embodiment, the user device 102 is configured to request and receive information from the publisher server 106, such as a web page that is provided by the publisher 108. The user device 102 may be configured to access other data/information in addition to web pages over the network 104 using a web browser, such as INTERNET EXPLORER® (sold by Microsoft Corp., Redmond, Wash.). The data displayed by the browser may include advertisements. In an alternative embodiment, software programs other than web browsers may also display advertisements received over the network 104 or from a different source.

In one embodiment, the publisher server 106 provides an interface to a network 104 and/or provides a web page to the user device 102. The publisher server 106 may be a web server that provides the user device 102 with pages (including advertisements) that are requested by a user of the user device 102. In particular, the publisher 108 may provide a web page, or a series of web pages that are provided by the publisher server 106 when requested from the user device 102. For example, the publisher may be a news organization, such as CNN® that provides all the pages and sites associated with www.cnn.com. Accordingly, when the user device 102 requests a page from www.cnn.com, that page is provide over the network 104 by the publisher server 106. As described below, that page may include advertising space or advertisement slots that are filled with advertisements viewed with the page on the user device 102. The publisher server 106 may be operated by a publisher 108 that maintains and oversees the operation of the publisher server 106.

The publisher 108 may be any operator of a page displaying advertisements that receives a payment from the advertisers of those advertisements. The publisher 108 may oversee the publisher server 106 by receiving advertisements from an advertiser server 122 that are displayed in pages provided by the publisher server 106. In one embodiment, an ad broker 112 may be used by the publisher 108 to select advertisements to be displayed, or the ad broker 112 may be used by the advertiser 124 to identify web pages (or publishers) with available advertisement space for displaying its ads.

The publisher database 110 may be coupled with the publisher server 106 and may store the publisher's pages or data that is provided by the publisher server 106. In addition, the publisher database 110 may include records or logs of at least a subset of the queries or requests for data/pages submitted to the publisher server 106 over a period of time. In one example, the publisher database 110 may include a history of Internet browsing data related to the pages provided by the publisher server 106. The data stored in the publisher database 110 may relate to or include various user information, such as preferences, interests, profile information or browsing tendencies, and may include the number of impressions and/or number of clicks on particular advertisements. The publisher database 110 may store advertisements from a number of advertisers, such as the advertiser 124. In addition, the publisher database 110 may store records on the advertisements that are shown and the resulting impressions and/or clicks for those advertisements. The data related to advertisement impressions, clicks and resulting actions may be stored in either the publisher database 110 and/or an advertiser database 126 and used in the matching process for identifying advertisements for publishers or identifying advertisement space for advertisers, as discussed below with respect to the ad broker 112. The data may be continuously updated to reflect current viewing, clicking and interaction with the advertisements displayed on the user device 102.

The advertiser server 122 may provide advertisements for display in web pages, such as the publisher's 108 pages. The advertiser 124 may be any operator of the advertiser server 122 for providing advertisements. The advertisements may relate to products and/or services provided by the advertiser 124. The advertiser 124 may pay the publisher 108 for advertising space on the publisher's 108 page or pages. The advertiser 124 may oversee the advertiser server 122 by providing advertisements to the publisher server 106. The advertisements may be provided by or through the ad broker 112. In one embodiment, the advertiser 124 may utilize the ad broker 112 for selecting the publisher 108 and the advertisement space for displaying its advertisements. For example, the advertiser 124 may be matched with the publisher 108 by the ad broker 112, so that the advertiser's 124 ads may be displayed in the publisher's 108 pages. The advertiser 124 may pay the publisher 108 for each impression and/or each click of the advertiser's displayed advertisement. The publisher 108 may utilize the ad broker 112 for selecting which advertisement is displayed in each advertisement slot.

The ad broker 112 may be coupled with the publisher server 106 and the advertiser server 122 for matching advertisements from the advertiser 124 with advertisement space on pages from the publisher 108. The ad broker 112 may receive advertisements from a number of advertisers, such as the advertiser 124. The advertiser server 122 may act as an interface for the advertiser 124 to provide advertisements to the ad broker 112. Likewise, the publisher server 106 may be an interface for the publisher 108 to provide advertisements space to the ad broker 112. The advertiser 124 and/or the publisher 108 may utilize the ad broker 112 for matching advertisements with available advertisement space. In one embodiment, an ad broker operator (not shown) may utilize the user device 102 to access the ad broker 112 over the network 104.

The ad broker 112 may be a computing device for matching advertisements with available ad space. The ad broker 112 may receive a request for ad space from the advertiser 124 and identify relevant ad space, such as the pages from the publisher 108. Likewise, the ad broker 112 may receive a request for an advertisement from the publisher 108 and identify a relevant advertisement, such as an advertisement from the advertiser 124. The ad broker 112 may include a processor 120, memory 118, software 116 and an interface 114. The ad broker 112 may be a separate component from the publisher server 106 and/or the advertiser server 122, or may be combined as a single component or device. For example, the publisher 108 may also control and operate the ad broker 112, which may be combined with the publisher server 106.

The interface 114 may communicate with any of the user device 102, the publisher server 106, and/or the advertiser server 122. The interface 114 may include a user interface configured to allow a user to interact with any of the components of the ad broker 112. For example, a user may be able to edit, add or remove items from a trail or update usage statistics that are used by the ad broker 112.

The processor 120 in the ad broker 112 may include a central processing unit (CPU), a graphics processing unit (GPU), a digital signal processor (DSP) or other type of processing device. The processor 120 may be a component in any one of a variety of systems. For example, the processor 120 may be part of a standard personal computer or a workstation. The processor 120 may be one or more general processors, digital signal processors, application specific integrated circuits, field programmable gate arrays, servers, networks, digital circuits, analog circuits, combinations thereof, or other now known or later developed devices for analyzing and processing data. The processor 120 may operate in conjunction with a software program, such as code generated manually (i.e., programmed).

The processor 120 may be coupled with a memory 118, or the memory 118 may be a separate component. The interface 114 and/or the software 116 may be stored in the memory 118. The memory 118 may include, but is not limited to computer readable storage media such as various types of volatile and non-volatile storage media, including to random access memory, read-only memory, programmable read-only memory, electrically programmable read-only memory, electrically erasable read-only memory, flash memory, magnetic tape or disk, optical media and the like. The memory 118 may include a random access memory for the processor 120. Alternatively, the memory 118 may be separate from the processor 120, such as a cache memory of a processor, the system memory, or other memory. The memory 118 may be an external storage device or database for storing recorded image data. Examples include a hard drive, compact disc (“CD”), digital video disc (“DVD”), memory card, memory stick, floppy disc, universal serial bus (“USB”) memory device, or any other device operative to store image data. The memory 118 is operable to store instructions executable by the processor 120.

The functions, acts or tasks illustrated in the figures or described herein may be performed by the programmed processor executing the instructions stored in the memory 118. The functions, acts or tasks are independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like. The processor 120 is configured to execute the software 116. The software 116 may include instructions for analyzing and identifying a trail to display based on a received query.

The interface 114 may be a user input device or a display. The interface 114 may include a keyboard, keypad or a cursor control device, such as a mouse, or a joystick, touch screen display, remote control or any other device operative to interact with the ad broker 112. The interface 114 may include a display coupled with the processor 120 and configured to display an output from the processor 120. The display may be a liquid crystal display (LCD), an organic light emitting diode (OLED), a flat panel display, a solid state display, a cathode ray tube (CRT), a projector, a printer or other now known or later developed display device for outputting determined information. The display may act as an interface for the user to see the functioning of the processor 120, or as an interface with the software 116 for providing input parameters. In particular, the interface 114 may allow a user to interact with the ad broker 112 to view or modify the analysis and identification of trails related to user queries.

The present disclosure contemplates a computer-readable medium that includes instructions or receives and executes instructions responsive to a propagated signal, so that a device connected to a network can communicate voice, video, audio, images or any other data over a network. The instructions may be transmitted or received over the network via a communication port or may be a separate component. The communication port may be created in software or may be a physical connection in hardware. The communication port may be configured to connect with a network, external media, display, or any other components in system 100, or combinations thereof. The connection with the network may be a physical connection, such as a wired Ethernet connection or may be established wirelessly as discussed below. Likewise, the connections with other components of the system 100 may be physical connections or may be established wirelessly.

The network or networks that may connect any of the components in the system 100 to enable communication of data between the devices may include wired networks, wireless networks, or combinations thereof. The wireless network may be a cellular telephone network, a network operating according to a standardized protocol such as IEEE 802.11, 802.16, 802.20, published by the Institute of Electrical and Electronics Engineers, Inc., or a WiMax network. Further, the network(s) may be a public network, such as the Internet, a private network, such as an intranet, or combinations thereof, and may utilize a variety of networking protocols now available or later developed including, but not limited to TCP/IP based networking protocols. The network(s) may include one or more of a local area network (LAN), a wide area network (WAN), a direct connection such as through a Universal Serial Bus (USB) port, and the like, and may include the set of interconnected networks that make up the Internet. The network(s) may include any communication method or employ any form of machine-readable media for communicating information from one device to another. For example, the publisher server 106 may provide pages to the user device 102 over a network, such as the network 104.

Any of the components in the advertising system 100 may be coupled with one another through a network, including but not limited to the network 104. For example, the ad broker 112 may be coupled with the publisher server 106 and/or the advertiser server 122 over a network. As another example, the advertiser database 126 may be coupled with the publisher server 106 and/or the ad broker 112 over a network. Accordingly, any of the components in the advertising system 100 may include communication ports configured to connect with a network.

The network or networks that may connect any of the components in the advertising system 100 to enable communication of data between the devices may include wired networks, wireless networks, or combinations thereof. The wireless network may be a cellular telephone network, a network operating according to a standardized protocol such as IEEE 802.11, 802.16, 802.20, published by the Institute of Electrical and Electronics Engineers, Inc., or WiMax network. Further, the network(s) may be a public network, such as the Internet, a private network, such as an intranet, or combinations thereof, and may utilize a variety of networking protocols now available or later developed including, but not limited to TCP/IP based networking protocols. The network(s) may include one or more of a local area network (LAN), a wide area network (WAN), a direct connection such as through a Universal Serial Bus (USB) port, and the like, and may include the set of interconnected networks that make up the Internet. The network(s) may include any communication method or employ any form of machine-readable media for communicating information from one device to another. For example, the ad publisher server 112 or the publisher server 106 may provide advertisements and/or content to the user device 102 over a network, such as the network 104.

The publisher server 106, the publisher database 110, the ad broker 112, the advertiser server 122, the advertiser database 126, the user device 102, the publisher 108, and/or the advertiser 124 may represent computing devices of various kinds. Such computing devices may generally include any device that is configured to perform computation and that is capable of sending and receiving data communications by way of one or more wired and/or wireless communication interfaces. Such devices may be configured to communicate in accordance with any of a variety of network protocols, including but not limited to protocols within the Transmission Control Protocol/Internet Protocol (TCP/IP) protocol suite. For example, the user device 102 may be configured to execute a browser application that employs HTTP to request information, such as a web page, from the publisher server 106. The present disclosure contemplates the use of a computer-readable medium that includes instructions or receives and executes instructions responsive to a propagated signal, so that any device connected to a network can communicate voice, video, audio, images or any other data over a network.

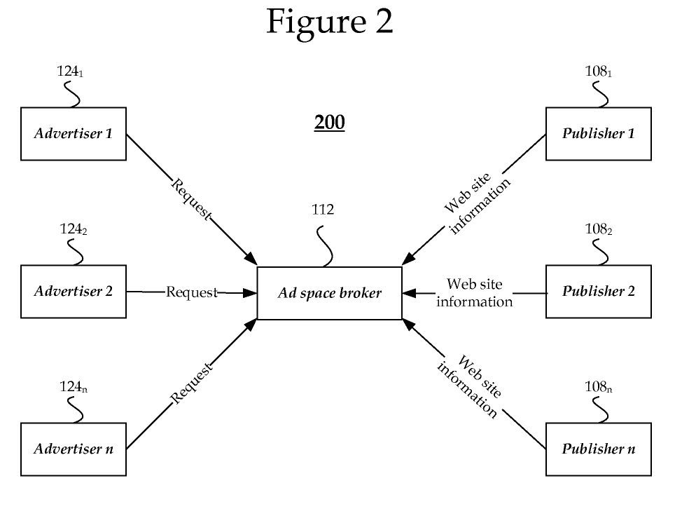

FIG. 2 is a diagram of another advertising network system. The ad broker 112 may receive requests or orders from advertisers 124 seeking to have their respective advertisements displayed on publisher 108 web sites. Likewise, the ad broker 112 may receive web site information from the publishers 108 that may be used for matching advertisements from advertisers 124 with the advertisement space on the publishers' 108 web sites. As illustrated, there may be n advertisers 124 and n publishers that utilize the ad broker 112. The value of n may be any integer including and above one. As described with respect to FIG. 1, the advertisers 124 and publishers 108 illustrated in FIG. 2 may include an advertiser server and publisher server, respectively, for providing the request/order and/or web site information.

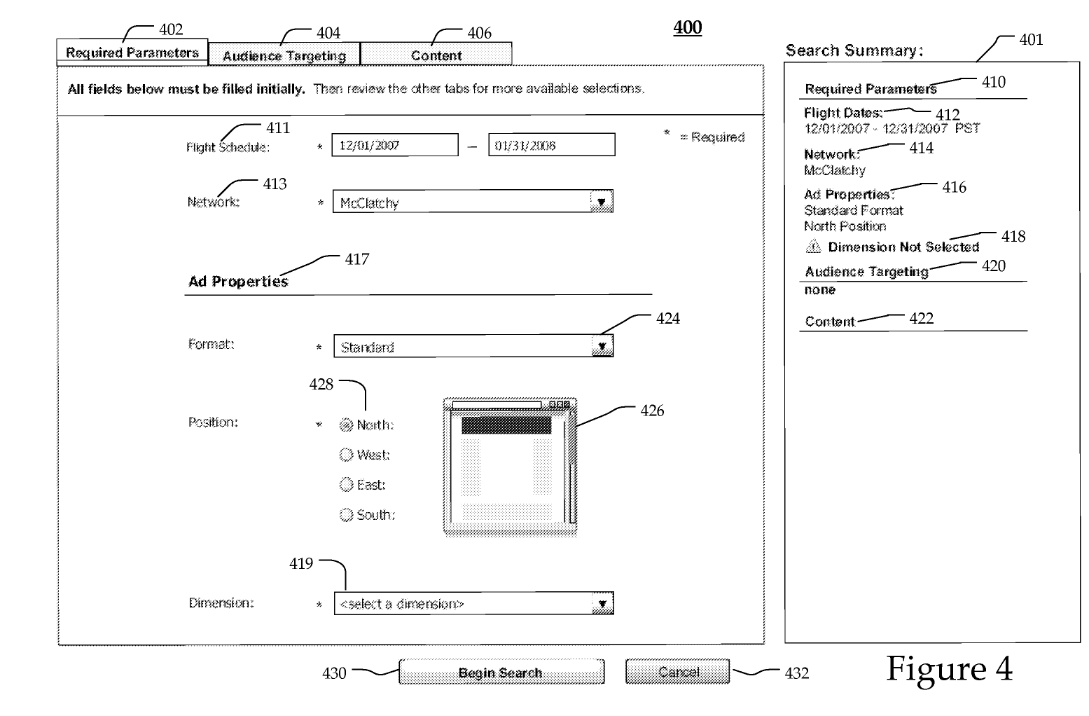

The request may include features, such as required parameters, audience targeting information, content information, or other inventory features. The inventory features may include information relevant to matching an advertisement with available advertising space. As described below with respect to FIGS. 4-19, the relevant information may include features such as a flight schedule, network, ad properties, ad format, ad position, ad dimension, demographic, behavioral, geographic, psychographic, technical, language, and/or other information about the ad or ad space content that may be specified in the request. The advertiser 100 may also include budget information. The budget information may correspond to a maximum amount of money that an advertiser 100 may be willing to spend on an advertising campaign.

The ad broker 112 may also receive web site information from publishers 110 that operate web sites with web pages that display advertisements in advertising space. The information may include any of the features listed above and described with respect to FIGS. 4-19. The publishers 110 may also specify a price range for displaying advertisements on their web pages. For example, the publishers 110 may specify a price for each advertisement impression. An impression may occur each time an advertisement is displayed on the publishers 110 web site.

The ad broker 112 may match advertiser 100 requests to publisher 108 web sites based on the provided information. After matching an advertisement with a publisher 108 web site, the ad broker 112 may provide the publisher 108 with a link to a server holding the advertiser's 100 advertisement. The publishers 110 may embed this link within the browser code utilized to render web pages on an Internet browser. This may enable the Internet browser to retrieve the advertisement.

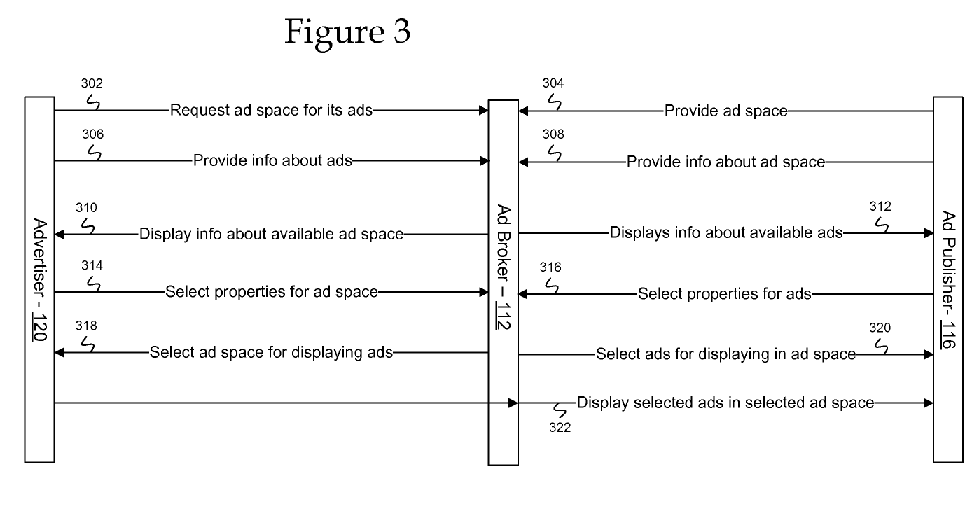

FIG. 3 is a diagram of an exemplary advertising interaction. In particular, FIG. 3 illustrates communication between the advertiser 120, the ad broker 112, and the ad publisher 116. As described, the communication between the ad broker 112 with the advertiser 120 and the ad publisher 116 may be through the advertiser server 118 and the publisher server 112, respectively. In block 302, the advertiser 120 may request ad space for its ads. The request may be for a single ad or for multiple ads. The request may be provided to the ad broker 112, who receives available ad space from the ad publisher 116 in block 304. As described in FIG. 2, there may be multiple advertisers providing advertisements and multiple ad publishers providing ad space.

The advertiser 120 provides information about its advertisements that it would like to display in block 306. The ad publisher 116 provides information about its available ad space that may be matched with advertisements in block 308. The ad information and the ad space information may be similar or the same categories of information that is used in matching ads with ad space. Exemplary information that may be provided may be inventory features that are illustrated in the screen shots in FIGS. 4-19 as described below.

The information received by the ad broker 112 from the advertiser 120 and the ad publisher 116 is then displayed. The available ad space information is displayed to the advertiser 120 in block 310 and the available ad information is displayed to the ad publisher 116 in block 312. That information is used by the advertiser 120 in selecting and/or identifying relevant properties for ad space to display its ads in block 314. Likewise, that information is used by the ad publisher 116 in selecting and/or identifying relevant properties for advertisements that may be displayed in block 316.

Based on the selected properties, the advertiser 120 may select the ad space for displaying ads in block 318. The ad space may be selected by narrowing the available ad space based on the ad space properties that are selected or narrowed. For example, the advertiser 120 may identify or narrow any of the ad properties or features. Likewise, the ad publisher 116 may select advertisements for displaying in its ad space in block 320. The advertisements may be selected by narrowing the available ads based on any of the ad properties or features described with respect to any of FIGS. 4-19. The selected ads from the advertiser 120 may then be displayed in the selected ad space of the ad publisher 116 in block 322. The ad broker 112 may act as an interface for the advertiser 120 and/or the ad publisher 116 for identifying relevant ads for ad space, or identifying relevant ad space for ads. The interface may be a software interface or web page as in the screen shots illustrated in FIGS. 4-19.

FIG. 4 is an exemplary user interface 400. The user interface 400 may be a web page or other software page that is displayed for either an advertiser or an ad publisher in matching advertisements with available ad space. For simplicity, the interface will be described for an advertiser viewing available ad space. The interface 400 includes a search summary pane 401 that updates automatically in near real-time as the advertiser selects features that narrow down the available ad publishers and/or available ad space. The search summary pane 401 may be a display of previously selected features and/or categories. The selected features may be displayed based on categories, such as the required parameters 410, audience targeting 420, and/or content 422 categories discussed below. The categorization of features within the search summary pane may provide a user-friendly, organized reference of those features that have already been selected or specified. The features and/or categories are described below with respect to the exemplary screen shots.

The advertiser may have three categories of features that include require parameters 402, audience targeting 404, and/or content 406. Each of those categories may include a variety of features that may be used to narrow down available ad space for matching with advertisements. As shown in FIG. 4, the required parameters 402 category is selected and its corresponding features. Accordingly, the search summary pane 401 displays a selection of the required parameters 410.

As the required parameters are selected, the search summary pane 401 may display the selected parameters/features as they are selected and updated. The flight schedule 411 includes the time frame that an ad is to be shown. When the flight schedule 411 is selected, the search summary pane 401 displays the corresponding flight dates 412. The flight dates may be used to match ads with ad space that is available during the flight dates. The network 413 may correspond with a classification of ad publishers. A group of sites may be classified as a single network, such as the sites associated with Yahoo.com®. The group may be based on subject matter (e.g. sports, news, blogs, etc.) and may be predefined. Websites associated with newspapers may be an example of a network. The selected network 414 is displayed in the search summary pane 401.

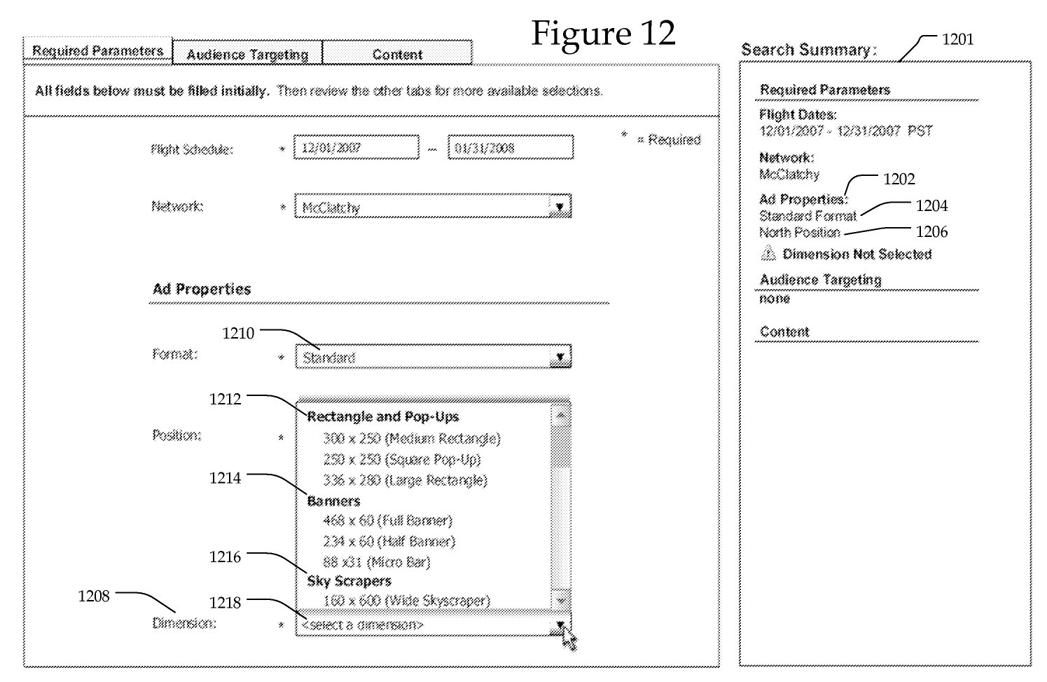

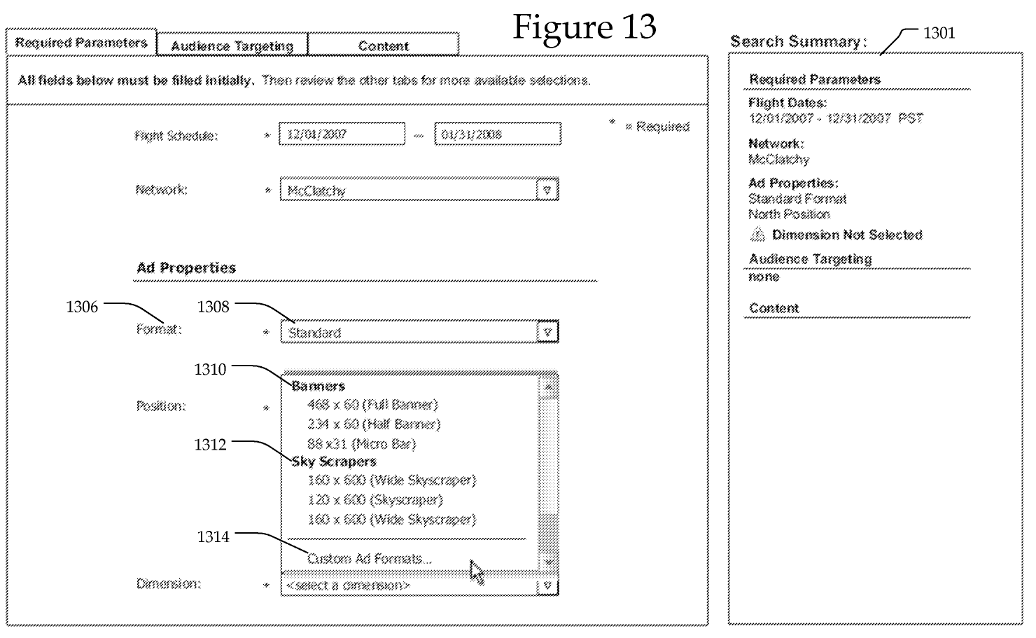

The ad properties 417 may include additional selectable features for matching ads with available ad space. The selected ad properties 416 are displayed in the search summary pane 401 as they are selected. The format 424 of an advertisement may include the type of ad and/or how the media is delivered. The format 424 may include text, image, audio, flash, rich media, video and/or any combination. The selected format is displayed under ad properties 416 in the search summary pane 401. The dimensions 419 of the advertisement may be selected with the selected dimension 418 displayed in the search summary pane 401. Exemplary ad format and dimension features are further illustrated in FIGS. 12-13.

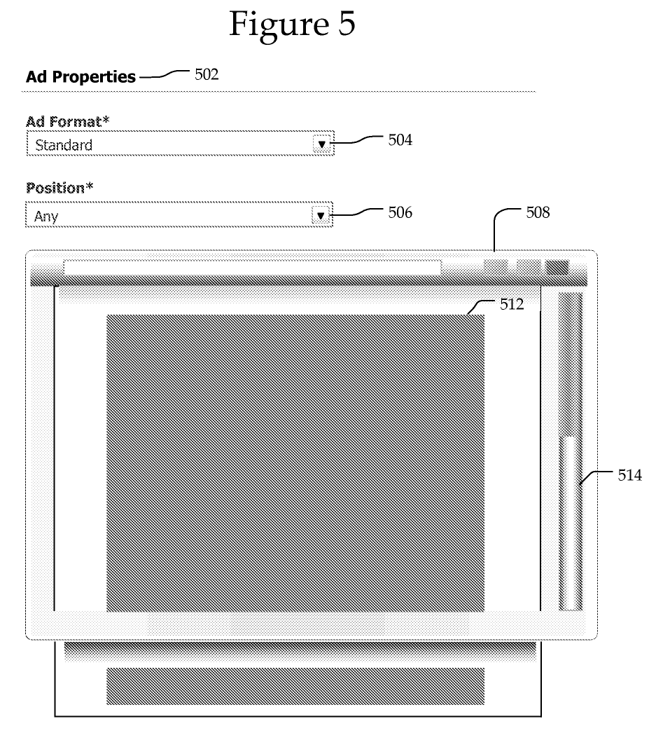

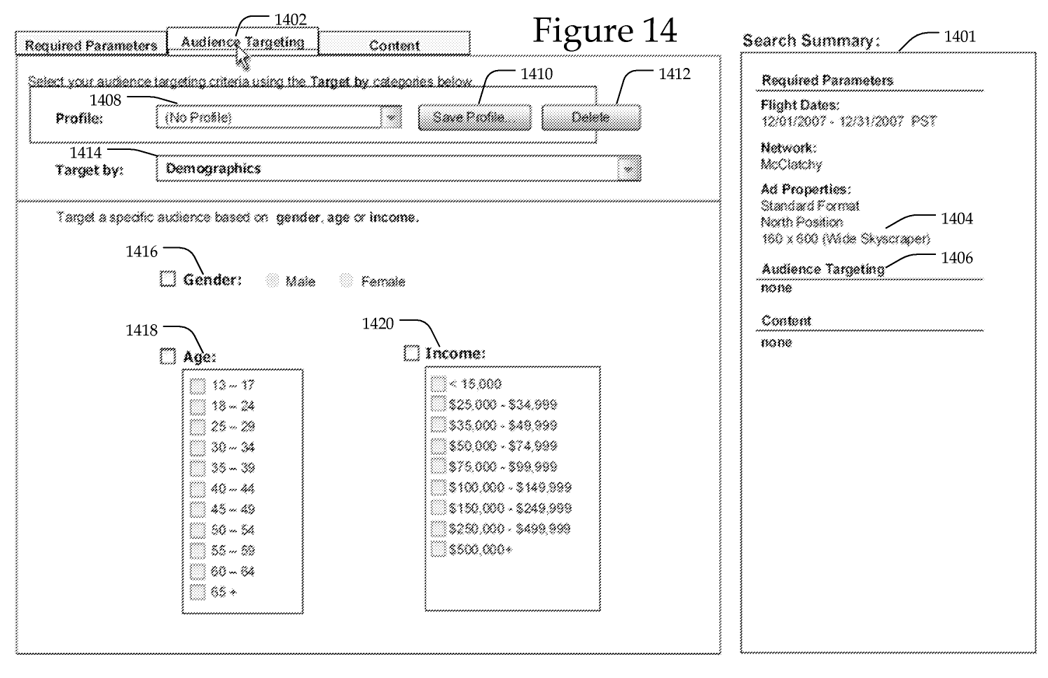

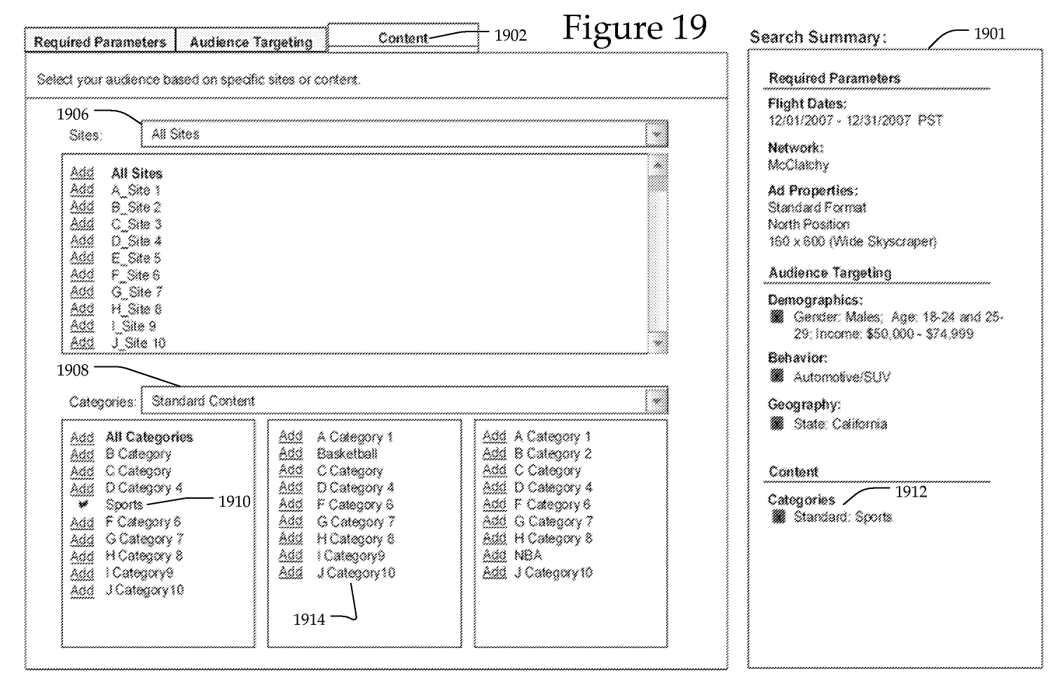

Another ad property is the position selector 428, which may also include a position viewer 426. The position may be the relative location within a page where an ad is displayed. FIGS. 5-11 are additional embodiments of the position selector 428 and/or position viewer 426. As shown in FIG. 4, the position selector 428 includes a position within the page, such as north (top of the page), west, (left side of the page), east (right side of the page), and/or south (bottom of the page). In one example, the north position may include a banner advertisement. The selected position is displayed under ad properties 416 in the search summary pane 401. The search summary pane 401 may also display the selected audience targeting 420 features and the selected content 422 features, which are selected through the audience targeting 404 and content 406 tabs, respectively. An exemplary audience targeting screen is shown in FIGS. 14-18 and an exemplary content screen is shown in FIG. 19. When the appropriate features have been selected as displayed in the search summary pane 401, the advertiser may click the begin search button 430 for identifying matching ad space. Likewise, the ad publisher may click the begin search button 430 for identifying matching ads. The cancel button 432 may be used to stop selecting and identifying relevant features.

FIG. 5 is an exemplary position viewer. FIG. 5 illustrates an alternate selection of ad properties 502, such as ad properties 417 shown in FIG. 4. The ad format 504 (compare format 424 in FIG. 4) may be selected from a list of options. As shown, the standard format is selected. The position 506 may also be selected and a position viewer 508 displays the ad automatically for a preview of the ad in the selected position in near real-time. In one example, the position viewer 508 may be displayed as the position viewer 426 from FIG. 4. The position viewer 508 may represent a page, such as the page on which the selected ad will be displayed. Accordingly, as the advertiser selects the position 506, the position viewer 508 displays an advertisement 512 in the selected position 506. The scroll bar 514 allows the preview window of the position viewer 508 to be scrolled. FIG. 5 illustrates that the selected position 506 is “Any” which may include a variety of positions. As shown, the advertisement 512 is displayed predominantly throughout the page previewed in the position viewer 508.

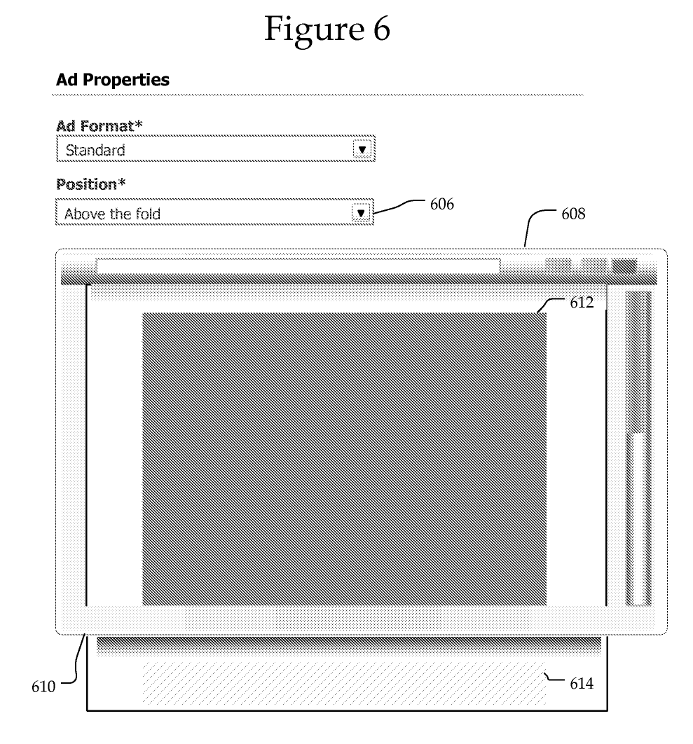

FIG. 6 is another exemplary position viewer. FIG. 6 illustrates an advertisement 612 displayed in a position viewer 608 at the selected position of above the fold 606. The above the fold position 606 may include displaying an ad in a window, such that the entire ad is displayed within the window without scrolling down to view more of the ad. Accordingly, the ad 612 may be displayed so that it is entirely within the initial viewable area of the page. As shown, a fold 610 of the preview is the bottom of the position viewer 608 and the page may extend below the fold 610. Accordingly, a portion 614 of the page may be displayed below the fold 610 and that portion 614 is visible when the screen is scrolled down below the fold 610. Accordingly, the ad 612 is displayed in the above the fold position 606.

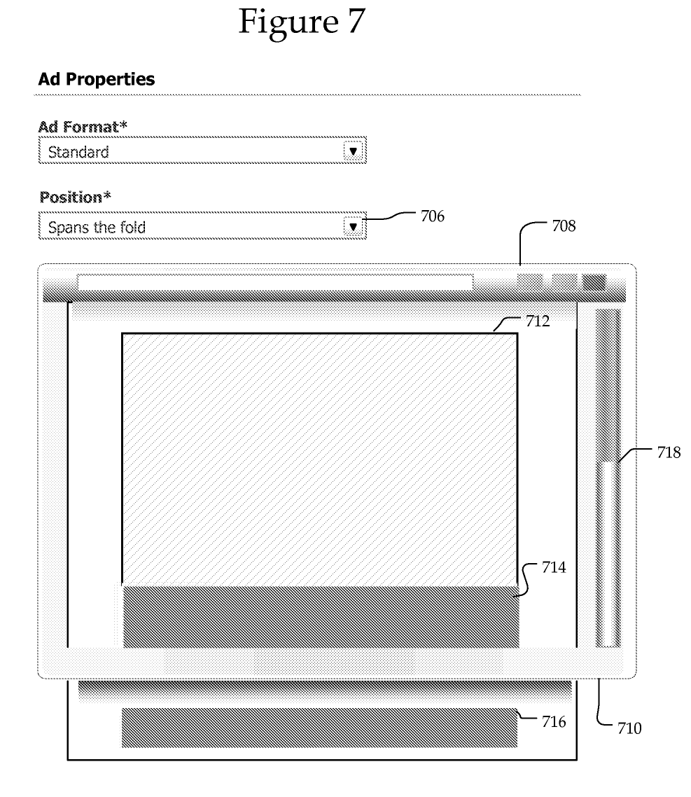

FIG. 7 is another exemplary position viewer. FIG. 7 illustrates an advertisement 714 that is displayed in a position viewer 708 in a spans the fold position 706. The spans the fold position 706 may include displaying the ad 714 both above and below a fold 710 in the page. The fold 710 may be a border between the currently visible page 712 and any portion of the page that is currently not visible without scrolling down with the scroll bar 718. A bottom portion 716 of the ad is displayed beneath the fold 710. When the scroll bar 718 moves the visible portion of the page down, the entire ad 714 with the bottom portion 716 may be visible. Accordingly, the ad 714 may be displayed so that it is not within the initial viewable area of the page and may be displayed underneath the initial viewable area of the page.

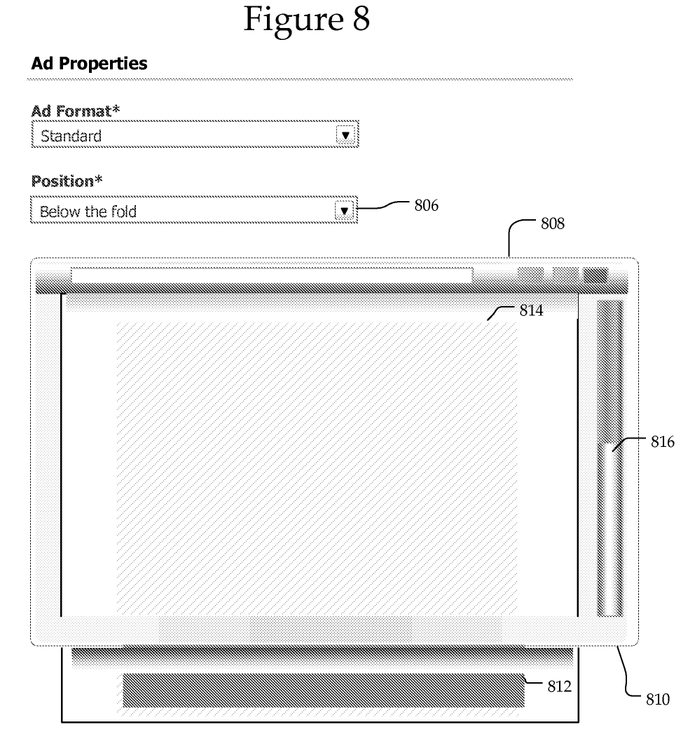

FIG. 8 is another exemplary position viewer. FIG. 8 illustrates an advertisement 812 that is displayed in a position viewer 808 in a below the fold position 806. The below the fold position 806 may include displaying the ad 812 beneath a fold 810 in the preview page. The main page 814 is displayed above the fold 810 and when the scroll bar 816 is used to scroll downwards, the ad 812 (that is below the fold) becomes visible in the screen. Accordingly, the ad 812 may be displayed underneath or below the initial viewable area of the page.

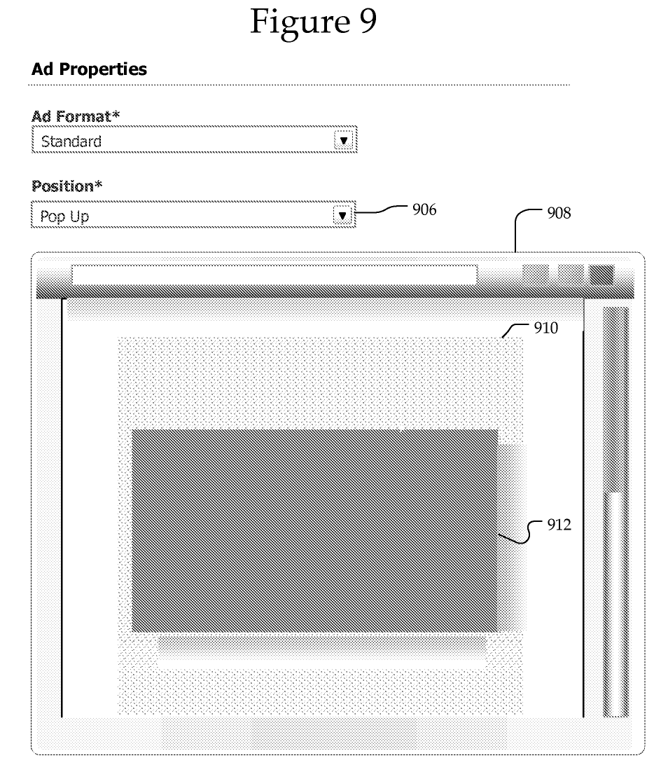

FIG. 9 is another exemplary position viewer. FIG. 9 illustrates an advertisement 912 that is displayed in a position viewer 908 in a pop-up position 906. The ad 912 is displayed as a pop-up advertisement that appears to be hovering over the main page 910. The pop-up ad 912 may be viewed as a layer that is on top of the main page 910, which appears beneath the pop-up ad 912. In one embodiment, the pop-up ad 912 may open as its own window or tab that is displayed separately from the main page 910 displayed in the position viewer 908. The pop-up ad 912 may be automatically displayed for a user in front of or on top of the other pages that a user may be viewing.

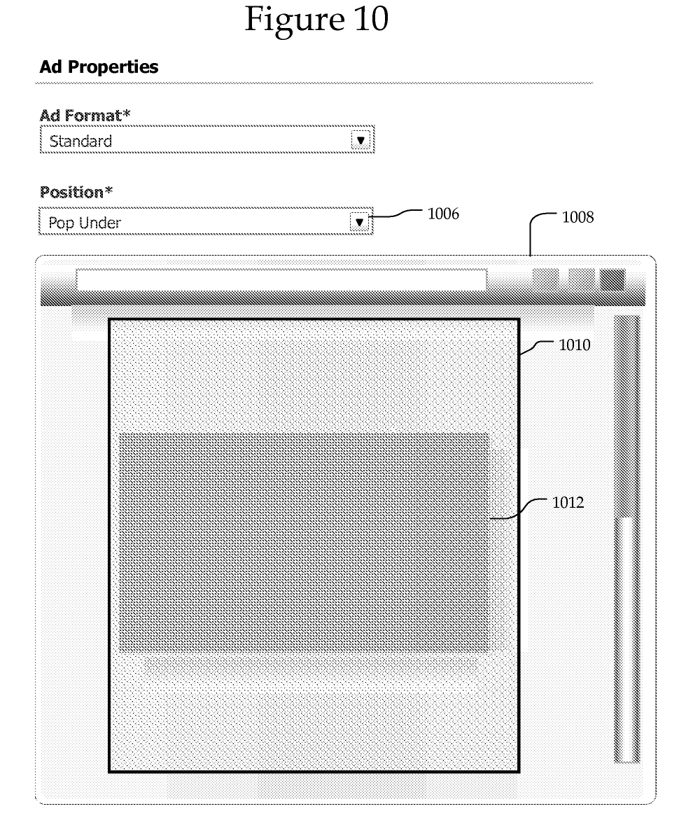

FIG. 10 is another exemplary position viewer. FIG. 10 illustrates an advertisement 1012 that is displayed in a position viewer 1008 in a pop-under position 1006. The ad 1012 is displayed as a pop-under advertisement that appears to below or beneath the main page 1010. The pop-under ad 1012 may be viewed as a layer that is below the layer of the main page 1010. In one embodiment, the pop-under ad 1012 may open as its own window or tab that is displayed separately from the main page 1010 displayed in the position viewer 1008. The main page 1010 may be a window that is covering up the window that includes the pop-under ad 1012. A user viewing the main page 1010 may not realize the pop-under ad 1012 is displayed until the main page 1010 is closed and the pop-under ad 1012 is viewable. Accordingly, the pop-under ad 512 may be less intrusive to a user's experience because the ad does not automatically appear in front of the user. Rather the ad is displayed once the user closes, moves, or minimizes the main page that is on top of the pop-under ad 1012.

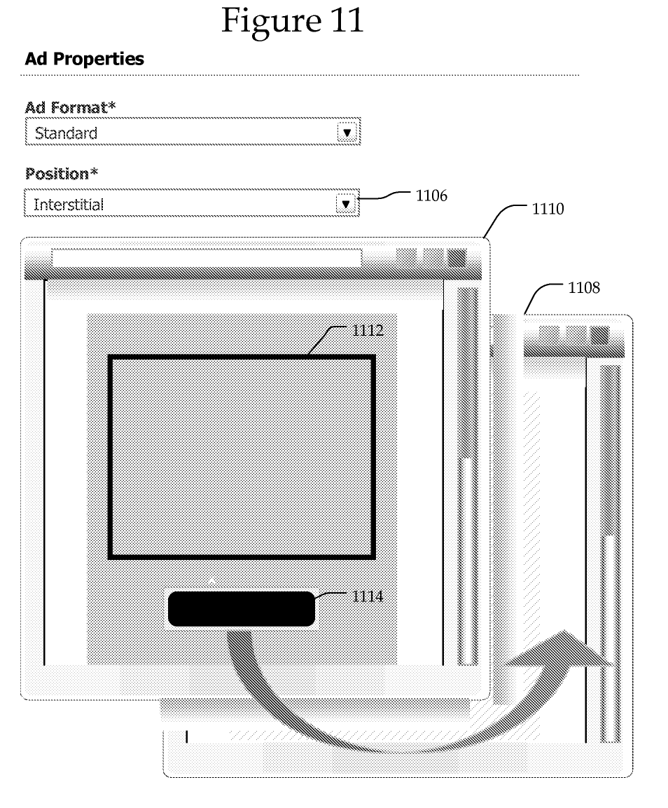

FIG. 11 is another exemplary position viewer. FIG. 11 illustrates an advertisement 1112 that is displayed in a position viewer 1108 in an interstitial position 1106. The ad 1112 may be displayed in an interstitial window 1112 that is displayed before allowing the user to view the main window of the position viewer 1108. The interstitial ad 1112 may be similar to a pop-up ad except it may be displayed temporarily to the user before proceeding to the main page. The interstitial ad 1112 may be a full page ad that is displayed within the main page and that is displayed temporarily or until the user clicks a button 1114 to bypass the interstitial ad 1112. Accordingly, the interstitial ad 1112 is displayed first before the content of the page is displayed.

FIGS. 5-11 include alternate embodiments of the position viewer 426 illustrated in FIG. 4. The position viewer may allow a user to view a preview of an advertisement based on a selected position. In one embodiment, an advertiser may select the position in which their ad should be displayed and the position viewer displays the ad in that position. The advertiser may change the position and the position viewer displays the ad in the changed position. The position viewer may be an automatic, real-time preview of an ad's position that may aid the advertiser in selecting the most appropriate position for any give ad.

FIG. 12 is another exemplary user interface. The user interface may be a web page or other software page that is displayed for either an advertiser or an ad publisher in matching advertisements with available ad space. For simplicity, the interface will be described for an advertiser viewing available ad space. The interface includes a search summary pane 1201 that updates automatically as the advertiser selects features that narrow down the available ad publishers and/or available ad space. The search summary pane 1201 displays ad properties 1202 that have been selected. For example, the format is selected as standard 1210, which is displayed as the standard format 1204 in the search summary pane 1201. Likewise, the position is selected as the north position as displayed in the search summary pane 1201.

The format 1210 and the dimension 1208 of the displayed ad may be selected within a drop-down box that lists a variety of formats and dimensions. The formats may include rectangle/pop-up 1212, banners 1214, and/or skyscrapers 1216. The format 1210 and dimension 1208 may be selected and the selected format 1204 and selected dimension 1209 are displayed in the search summary pane 1201. A rectangle/pop-up ad 1212 may have different dimensions. For example, a medium rectangle ad may have a pixel size of 300×250. A large rectangle may have a size of 336×280 and a square pop-up ad may have a size of 250×250. These ads are exemplary of possible rectangular and/or pop-up ads and other shapes and sizes are possible. The ad may be a banner ad 1214. The banner may be a full banner, a half banner, or a micro bar with dimensions of 468×60, 234×60, and 88×31, respectively. These banner sizes are merely exemplary and other shapes and sizes are possible for banner ads 1214. Sky scrapers 1216 may be another format of the ad with different dimensions. A sky scraper may be a wide sky scraper with a size of 160×600. Other shapes and sizes of sky scraper ads 1216 are possible. There may be additional formats 1210 and dimensions 1218 available for selection.

FIG. 13 is another exemplary user interface. The interface may include a search summary pane 1301 that updates automatically as features are selected that narrow down the available ads and/or available ad space for matching the ads with the ad space. The search summary pane 1301 displays the ad properties and features that have been selected. As in FIG. 12, the ad format 1306 is selected as standard 1308. A drop down box may be displayed for selecting a different ad format 1306 and dimension. Banner ads 1310 is one example of a format with different dimensions. Likewise, sky scraper ads 1312 is another ad format with different dimensions. The skyscraper ad 1312 may be a skyscraper with a dimension of 120×600, or a wide skyscraper with a 160×600 dimension. Alternatively, other formats or dimensions may be available and selected for display. For example, there may be custom ad formats 1314 that are selected. Those selected formats and/or dimensions may be displayed in the search summary pane 1301 as they are selected.

FIG. 14 is another exemplary user interface. The interface may include a search summary pane 1401 that updates automatically as features are selected that narrow down the available ads and/or available ad space for matching the ads with the ad space. The search summary pane 1401 displays the ad properties and features that have been selected. For example, the wide skyscraper format 1404 had been selected and displayed in the search summary pane 1401. FIGS. 12-13 illustrated exemplary features that were displayed under the required parameters tab. The audience targeting tab 1402 is selected in FIG. 14 as the category of features available for selection. The audience targeting features 1406 are displayed in the search summary pane 1401 as they are selected. The audience targeting features may be used for targeting the ads to certain audiences.

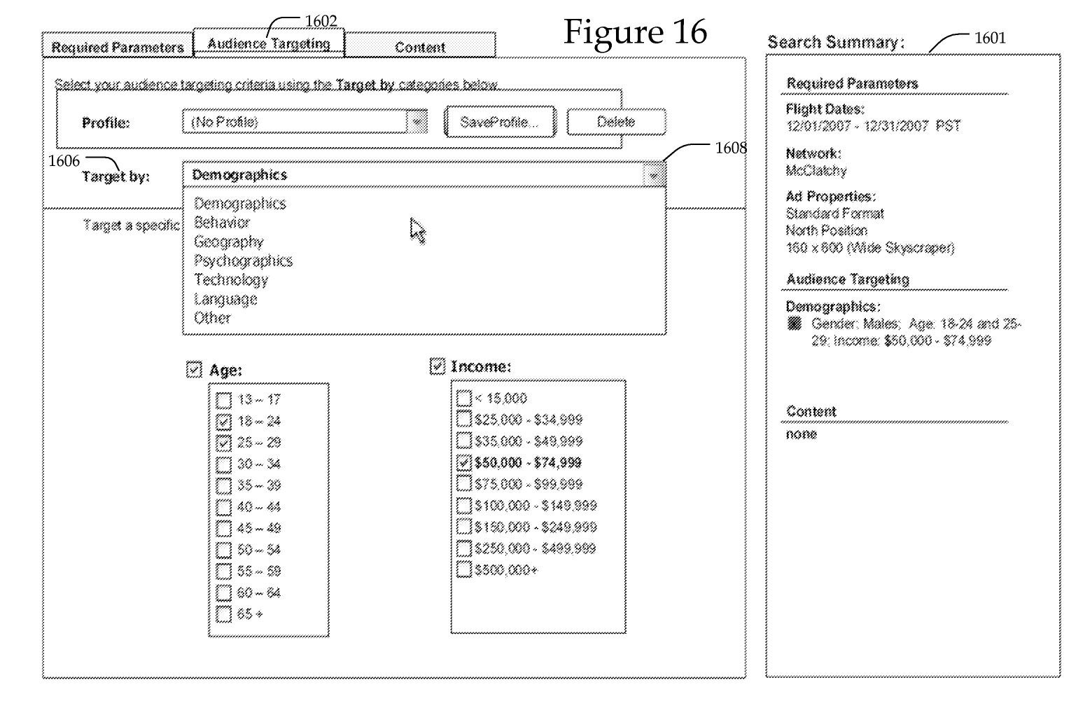

A profile 1408 may be saved with certain audience targeting features that are selected. For example, an advertiser may create a profile with a set of features that is saved with the save profile button 1410. A saved profile may be deleted with the delete button 1412. Demographic, behavioral, geographic, technical, or other features may be saved in a profile. The audience may be targeted by demographics 1414 as further described with respect to FIG. 16. An ad may further be targeted by gender 1416, age 1418, and/or income 1420. As the demographics, such as the gender 1416, age 1418, and/or income 1420 are selected, they are displayed in the search summary pane 1401.

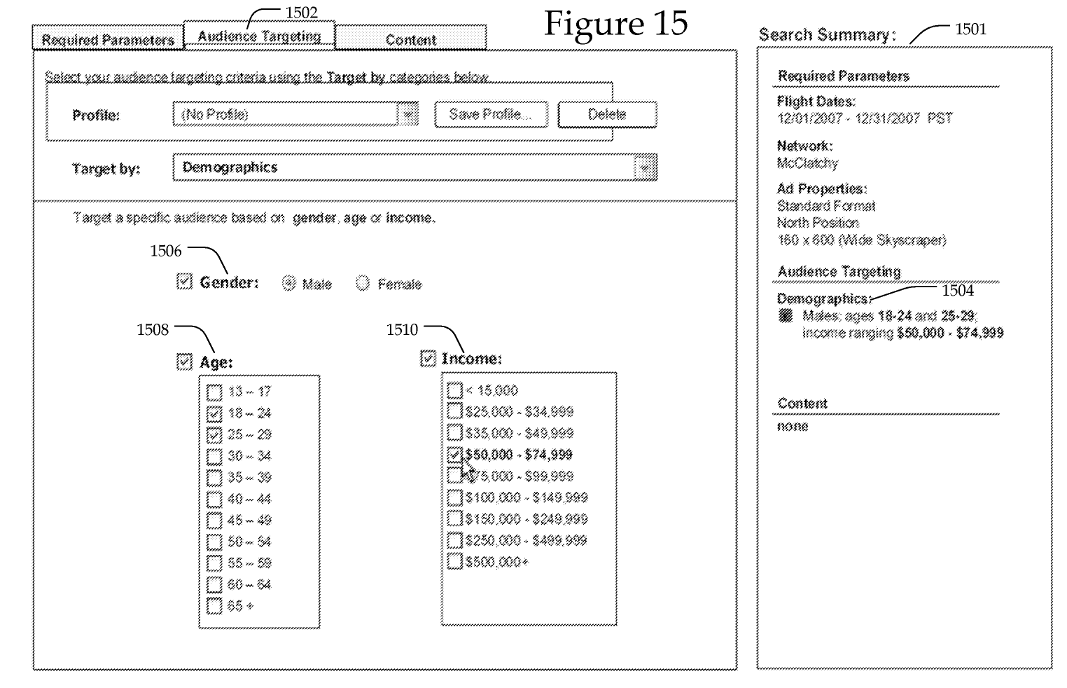

FIG. 15 is another exemplary user interface that illustrates that the search summary pane 1501 is updated as audience targeting features 1502 are updated. As shown, the gender 1506 is selected as male. The age 1508 is selected as both 18-24, and 25-29. The income 1510 is selected as $50,000-$74,999. The gender 1506, age range 1508, and income 1510 are all selected and displayed under audience targeting 1504 in the search summary pane 1501. Accordingly, as the audience targeting features are selected, they are displayed in the search summary pane 1501.

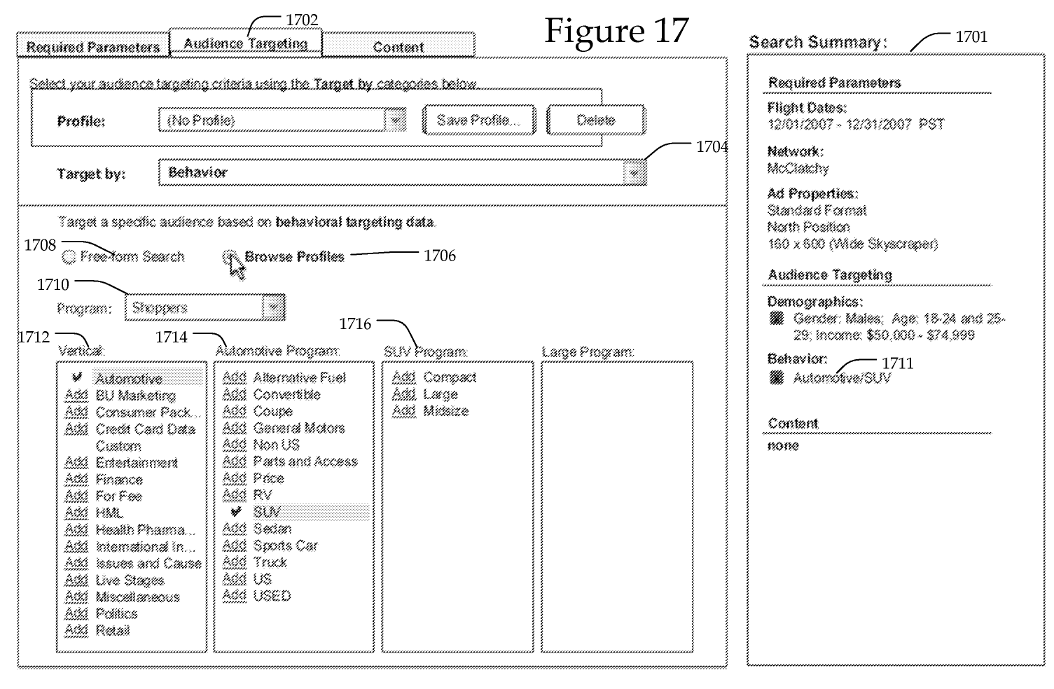

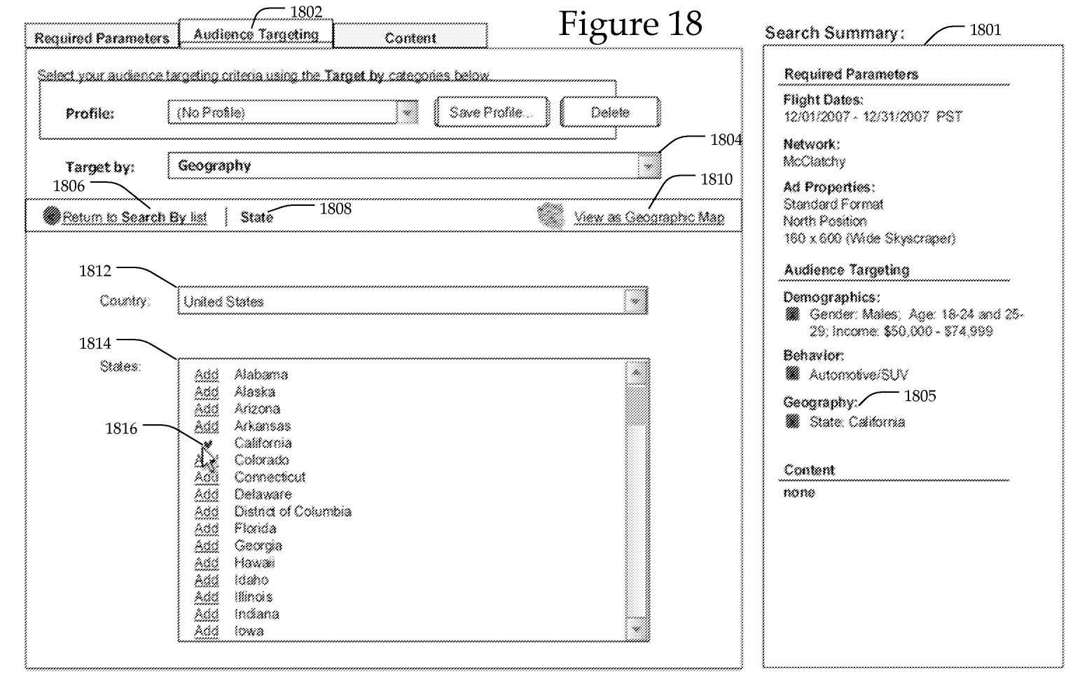

FIG. 16 is another exemplary user interface that illustrates targeting demographics 1606. The targeting demographics 1606 may be listed in a drop-down box 1608. The search summary pane 1601 may be updated as audience targeting 1602 features including the targeting demographics 1606 are updated. The targeting demographics 1606 may include demographics, behavior, geography, psychographics, technology, language, or other categories. The demographics may be gender, age, and/or income as illustrated in FIG. 15. The behavior category is described with respect to FIG. 17 and the geography category is described with respect to FIG. 18. Psychographics may include attributes relating to personality, values, attitudes, interests, or lifestyles. Technology may include the browser, operating system, network connection, and/or computer of a user. For example, an ad may be targeted only to users that have a broadband network connection, or users that have a wireless network. Language may include different language ads. For example, an advertiser may want an ad displayed on both English and Spanish websites. There may be other targeting categories that are used by an advertiser in narrowing down advertising space for their ads.

FIG. 17 is another exemplary user interface that illustrates audience targeting based on behavioral features 1704. The search summary pane 1701 may be updated as audience targeting 1702 features including the behavioral features 1704 are updated. An audience may be targeted based on behavioral targeting data. In one embodiment, the behavioral features 1704 that are available may be searched using a free-form search 1708. The free-form search may provide the user (such as an advertiser) with the ability to search for features and/or categories for narrowing user behavior. For example, the user could search for car and the features and/or categories related to cars may be available. Alternatively, the user may browse profiles 1706 for identifying features. There may be several programs 1710 to choose from. The programs 1710 may be categories of features. As shown, the program 1710 is shoppers and there are various sub-categories 1712, 1714, and 1716. The vertical sub-category 1712 includes a number of categories that may be used for behavioral targeting. After “Automotive” is selected in the vertical sub-category 1712, the automotive program is a second sub-category 1714. After “SUV” is selected in the automotive program sub-category 1714, the SUV program is a third sub-category 1716. Accordingly, shoppers of compact SUV's may be targeted when compact in the SUV program sub-category 1716.

FIG. 18 is another exemplary user interface that illustrates audience targeting based on geographical features 1804. The search summary pane 1801 may be updated as audience targeting 1802 features including the geographical features 1804 are updated. An audience may be targeted based on geographical targeting data. For example, an advertiser may want an ad to be displayed in the South or displayed only in urban locations. Accordingly, the user interface allows the user (such as an advertiser) to specify a geographic location. The selected geographic location may be used to narrow down the available ads and available ad space for matching an appropriate ad with an appropriate ad space in the same geographic location.

In one embodiment, the geographical features 1804 that are available may be selected using a geographic map 1810. The geographic map 1810 may be interactive and allow for the selection of an area on the map. For example, a region, state, zip code, city, town, and/or neighborhood may be selected as the relevant geographic location on the map 1810. The geographical features 1804 may also be selected based on a demographic marketing area (“DMA”). A DMA may be a group of cities or a single metropolitan area (e.g., Bay area, or New York City). A DMA may span across cities, states, and/or zip codes, so the DMA may be displayed as a different geographic option. Multiple DMA's may be available for selection and those DMA's may overlap.

There may be a search list 1806 that is used to select a geographic category to list. For example, the state 1808 may be a list term that is used to narrow down the relevant geographical location. The country 1812 may be used to narrow down an appropriate location. A state sub-category 1814 may be available when the United States is selected as the country 1812. As shown, the state of California 1816 is selected. The search summary pane 1801 is updated as the state of California 1816 is selected. Accordingly, the geography category 1805 of audience targeting in the search summary pane 1801 is updated to display California as the selected geography.

FIG. 19 is another exemplary user interface with content targeting. The content 1902 is selected as the overall category for narrowing features. The content category may include selecting or identifying an audience based on specific sites or content. For example, an advertiser may include a list of sites that are the only sites the advertiser wants their ads to appear on. As shown, there may be a sites drop-down box 1906 for selecting available sites. The advertiser may view a listing of sites with available ad space. Alternatively, the content may be narrowed based on content categories 1908. The content categories 1908 may include a description of the content of a group of sites. For example, the content category may include news, sports, finance, blogs, entertainment, gossip, or any other category that classifies and groups web sites with similar content. A sub-category of content 1914 may further be used to narrow down the relevant content. For example, the Sports category may include a Basketball sub-category and an NBA second sub-category.

When the relevant category and/or sub-categories are selected, the search summary pane 1901 is updated, so that the content category 1912 displays the selected category. As described, the search summary pane 1901 includes a real-time or near real-time display of the features and/or categories that are selected for narrowing down ad space or ads for matching ads with ad space. Accordingly, an advertiser may select various features and/or categories that are displayed in the search summary pane 1901 and those selected features and/or categories may be used to identify available ad space that matches those selections. The search summary pane 1901 may be displayed on each selection screen, so that the user can reference those features that have already been selected while further narrowing down the available ads or ad space.

Referring back to FIG. 4, the user may click the begin search button 430 to identify available ads or ad space based on the selected features and/or categories discussed in FIGS. 5-19. As described, an advertiser may identify features and/or categories that are relevant to the ad space in which the advertiser wants to display its ads. Likewise, an ad publisher may identify features and/or categories that are relevant to the ads that it wants to display on its sites. The features that have been identified are displayed in the search summary pane 401 of the user interface 400. When the user clicks the begin search button 430, a list of matching ad space is shown to an advertiser and a list of matching ads are shown to an ad publisher. The respective lists may be referred to as available inventory and are used for matching ads with ad space. The process of matching available ads with available ad space may be referred to as inventory selection.

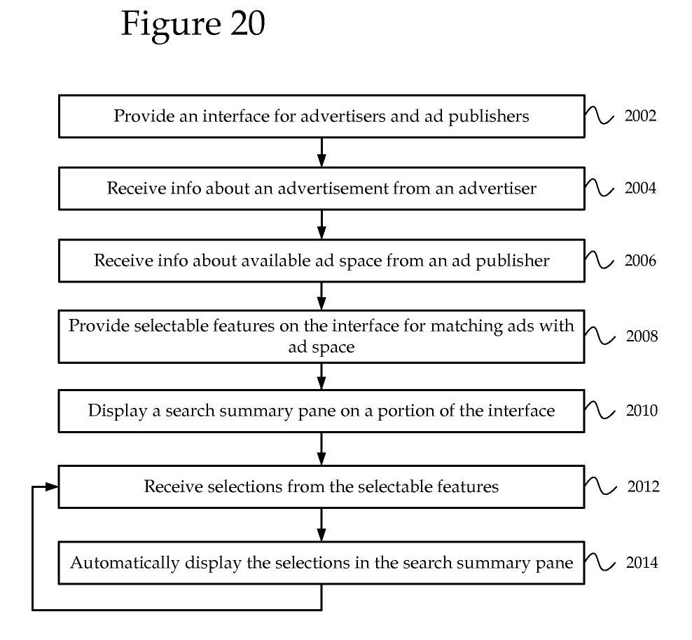

FIG. 20 is a diagram using a search summary pane. The search summary pane may be an on-screen itemization of selected features, parameters, or categories used to match ads with available ad space. As described above in FIG. 4 and FIGS. 12-19, a search summary pane is displayed in an interface for advertisers and/or ad publishers as in block 2002. The interface may be a part of an ad broker that matches advertisements with available ad space. In block 2004, information about an advertisement is received from the advertiser. Likewise, in block 2006, information about available ad space is received from the ad publisher. The information may include features about the advertisement or features about the ad space that is used in identifying relevant ad space for the advertisement and identifying relevant advertisements for the ad space.

In addition, selectable features may be provided within the interface in block 2008. The selectable features may include further information about either the advertisement or the ad space. For example, the advertiser may identify and select features about its advertisement and/or about the ad space for displaying its advertisement. Likewise, the ad publisher may identify and select features about its ad space and/or about the ads to be displayed in its ad space. Those features may be used to identify for an advertiser relevant ad space for its advertisement and also be used to identify for an ad publisher relevant ads for displaying in its ad space. The selectable features may include parameters or categories, such as flight schedule, network, ad format, ad position, and/or ad dimension. The selectable features may also include audience targeting parameters or categories, such as demographics, behavior, geography, psychographics, technology, language, and/or other targeting parameters. The selectable features may include information about the content of the ads and the available ad space. The content information may include a categorization of the content of the advertisement and/or available ad space.

A search summary pane may be displayed on the interface in block 2010. As illustrated in FIG. 4, the search summary pane 401 is displayed on a right portion of the interface 400. In one embodiment, the search summary pane is consistently displayed in the interface as either the advertiser and/or the ad publisher view the inventory for available ad space and advertisements, respectively. The search summary pane 401 may be displayed in other locations within the interface 400. The search summary pane provides a user with a reference for those features that have been selected. Accordingly, when selections of features have been received in block 2012, those selected features are automatically displayed in the search summary pane in block 2014. As the user continues to select additional features, the search summary pane is automatically updated to display those selections. Likewise, if a user modifies or changes previously selected features, those changes are displayed in the search summary pane automatically. The features from the search summary pane may be displayed in near real-time with the selection of features.

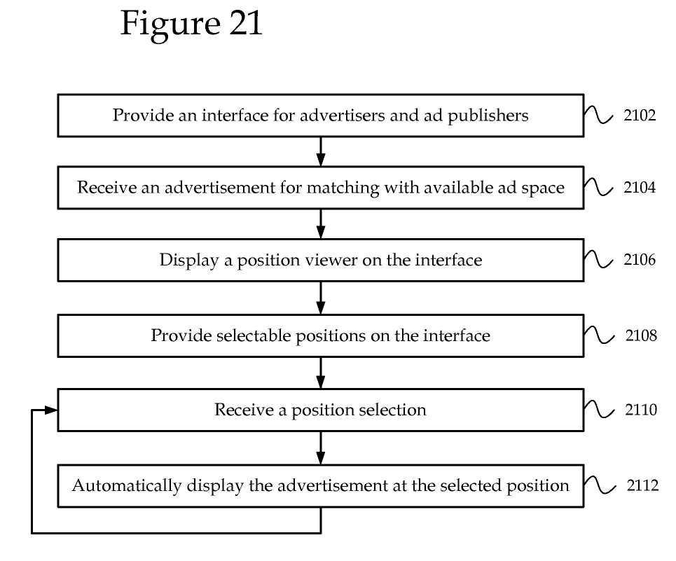

FIG. 21 is a diagram using a position viewer. As described above in FIGS. 4-11, a position viewer is displayed in an interface for advertisers and/or ad publishers as in block 2102. The interface may be a part of an ad broker that matches advertisements (from advertisers) with available ad space (from ad publishers). In block 2104, an advertisement is received from the advertiser to be matched with the available ad space. The advertiser may utilize the interface to view and select available ad space that matches certain features that the advertiser specifies. The interface may display a position viewer as in block 2106. The interface may provide selectable positions as in block 2108.

As described with respect to FIGS. 4-11, the selectable positions may be one feature that is used to match ads with ad space. The positions that may be selected include north, south, east, west, any, above the fold, spans the fold, below the fold, pop-up, pop-under, and/or interstitial. Other ad positions may also be available. In block 2110, the advertiser selects the position in which its advertisement should be displayed. Upon the position selection, the position viewer displays the advertisement at that selected position in block 2112. Any change in the selected position results in a change in the position displayed in the position viewer. The position viewer may be a preview for the advertiser to assist in selecting an optimal position for its advertisement. The preview of the ad position may help the advertiser identify those positions that may not work for a particular advertisement. The position viewer may display a smaller or miniaturized version of a page with the advertisement displayed on that smaller version of the page at the selected position. Accordingly, the position viewer may be an embedded area or portion of the interface that changes as the selected position changes.

The system and process described may be encoded in a signal bearing medium, a computer readable medium such as a memory, programmed within a device such as one or more integrated circuits, and one or more processors or processed by a controller or a computer. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

We claim:

1. A method for an advertiser purchasing space for displaying an advertisement comprising:
receiving a request for the advertisement to be displayed;
receiving a plurality of advertisement slots from at least one publisher, wherein the space comprises at least one of the plurality of advertisement slots;
providing to the advertiser at least one page for a selection of parameters, wherein the selected parameters determine which of the plurality of advertisement slots displays the advertisement; and
displaying a real-time itemization of the parameters that are selected by the advertiser.

2. The method of claim 1 wherein the parameters comprise a flight schedule, a network, ad properties, an ad format, an ad position, an ad dimension, demographics, behavioral data, geographic data, psychographic data, technical information, a language, content information, or combinations thereof.

3. The method of claim 1 wherein the real-time itemization comprises a search summary pane that displays the selected parameters.

4. The method of claim 3 wherein the search summary pane is displayed on a portion of each of the at least one pages.

5. The method of claim 1 further comprising:
receiving the selection of parameters; and
updating the real-time itemization of the parameters as the selection is received.

6. The method of claim 1 further comprising identifying ad slots from the plurality of advertisement slots that match the selected parameters.

7. A system for narrowing down available ad space for displaying an advertisement comprising:
an advertiser that provides the advertisement;
a plurality of ad publishers that provide the available ad space; and
an ad broker coupled with the advertiser and the plurality of ad publishers that receives information about the advertisement and information about the available ad space, wherein the ad broker comprises:
an interface that provides a list of features that displays features for selection, wherein the selection of the features narrows down available ad space, wherein the ad space that is available corresponds with the feature selections; and
a search summary pane displayed on the interface that displays the selected features automatically as they are selected from the interface.

8. The system of claim 7 wherein the list of features comprises a flight schedule, a network, ad properties, an ad format, an ad position, an ad dimension, demographics, behavioral data, geographic data, psychographic data, technical information, a language, content information, or combinations thereof.

9. The system of claim 7 wherein the search summary pane comprises an itemized list of selected features, further wherein the selected features are displayed as they are selected from the interface.

10. A method for displaying selected features for matching advertisements with available ad space;
providing an interface with selectable features related to the advertisements, wherein the selectable features are used to match the advertisements with the available ad space;
displaying a search summary pane in a portion of the interface, the search summary pane configured to display features that have been selected from the selectable features;
receiving selections of features from the selectable features at the interface; and
displaying each of the received selections in the search summary pane as the selections are received.

11. The method of claim 10 wherein the portion of the interface comprises a side of the interface.

12. The method of claim 10 wherein the received selections are displayed in the search summary pane in near real-time.

13. The method of claim 10 wherein the features comprise a flight schedule, a network, ad properties, an ad format, an ad position, an ad dimension, demographics, behavioral data, geographic data, psychographic data, technical information, a language, content information, or combinations thereof.

14. The method of claim 10 further comprising:
providing a list of potential advertisement slots based on the selected features;
receiving a selection of at least one advertisement slot from the list of potential advertisement slots; and
providing the advertisement for display in the at least one advertisement slot.

15. In a computer readable storage medium having stored therein data representing instructions executable by a programmed processor for an advertiser to purchase space to display an advertisement, the storage medium comprising instructions operative for:
accessing an inventory of available advertisement slots, wherein the inventory is organized based on features about the advertisement;
receiving a selection from the advertiser for at least a portion of the features;
displaying a summary pane of the selected features;
updating the summary pane automatically to display each of the selected features as they are selected; and
providing a list of potential advertisement slots based on the selected features.

16. The computer readable medium of claim 15 wherein the space to display the advertisement comprises the advertisement slots.

17. The computer readable medium of claim 15 wherein the features comprise a flight schedule, a network, ad properties, an ad format, an ad position, an ad dimension, demographics, behavioral data, geographic data, psychographic data, technical information, a language, content information, or combinations thereof.

18. The computer readable medium of claim 15 further comprising providing a page where at least a portion of the features are accessible and selectable.

19. The computer readable medium of claim 18 wherein the summary pane is displayed on a portion of the page.

20. The computer readable medium of claim 15 wherein the summary pane is updated in near real-time to display each of the selected features as they are selected.

21. The computer readable medium of claim 15 further comprising:
receiving a selection of at least one advertisement slot from the list of potential advertisement slots; and
providing the advertisement for display in the at least one advertisement slot.
